(19) United States
(12) Patent Application Publication
(10) Pub. No.: US 2008/0016282 A1
(43) Pub. Date: Jan. 17, 2008

(54) Cache memory system

(76) Inventor: Kazuhiko Sakamoto, Osaka (JP)

Correspondence Address: MCDERMOTT WILL & EMERY LLP, 600 13TH STREET, NW, WASHINGTON, DC, 20005-3096, US

(21) Appl. No.: 11/819,363

(22) Filed: Jun. 27, 2007

(30) Foreign Application Priority Data
Jun. 28, 2006 (JP) 2006-177798

(51) Int. Cl. G06F 12/00

(52) U.S. Cl. 711/131; 711/E12.001

(57) ABSTRACT

A cache memory system includes: a plurality of cache lines, each including a data section for storing data of main memory and a line classification section for storing identification information that indicates whether the data stored in the data section is for instruction processing or for data processing; a cache hit determination section for determining whether or not there is a cache hit by using the identification information stored in each of the cache lines; and a cache update section for updating one of the cache lines that has to be updated, according to result of the determination.

### CROSS-REFERENCE TO RELATED APPLICATION

This application claims priority under 35 U.S.C. §119 on Patent Application No. 2006-177798 filed in Japan on Jun. 28, 2006, the entire contents of which are hereby incorporated by reference.

### BACKGROUND OF THE INVENTION

The present invention relates to memory devices, and more particularly relates to a cache memory system which is used to reduce accesses to main memory.

In recent years, cache memory systems have been widely used to enhance the processing speed of microcomputers. A cache memory system is a mechanism in which frequently-used data is stored in high-speed memory (cache memory) in or close to a CPU to reduce accesses to low-speed main memory and hence increase processing speed. Cache memory systems are broadly divided into the following two types of systems according to whether or not instruction memory and data memory are separated.

FIG. 6 is a block diagram illustrating the configuration of a unified cache. The unified cache shown in FIG. 6 includes a cache memory 603, a bus 604, and an arbitration control section 605. In the unified cache shown in FIG. 6, the cache memory 603 and the bus 604 are shared by instruction processing and data processing. In this system, when instruction processing and data processing try to access the cache memory 603 at the same time, the arbitration control section 605 delays one processing until the other processing is completed. Thus, in this system, when parallel processing is performed, processing efficiency decreases.

FIG. 7 is a block diagram illustrating the configuration of a separate cache. The separate cache shown in FIG. 7 includes an instruction cache 705, a data cache 706, and buses 703 and 704. In the separate cache shown in FIG. 7, two lines, each including a cache memory and a bus, are provided separately for instruction processing and data processing. In this system, when cache memory resources are accessed, no access conflict occurs between instruction processing and data processing, and processing efficiency in parallel processing thus does not decrease. However, the presence of the two separate lines causes the utilization efficiency of the cache memories to be lowered and the circuitry to be increased in complexity and size.

In view of these drawbacks, a multiport unified cache, which enables simultaneous accesses from a plurality of ports to the same memory array, is disclosed in Japanese Laid-Open Publication No. 63-240651, for example.

FIG. 8 is a block diagram illustrating the configuration of a multiport unified cache. The multiport unified cache shown in FIG. 8 includes a multiport cache 805 and buses 803 and 804. The multiport unified cache can simultaneously receive accesses from a plurality of ports to the same memory array. Thus, if instruction processing and data processing are allocated to different ports, no access conflict occurs.

There are two types of multiport unified caches: multiport memory, which is multiplexed by cell units (minimum memory units), and bank-based multiport memory, which is multiplexed by bank block units.

Multiport memory multiplexed by cell units achieves complete multiplexing of access to the memory array. However, in multiport memory multiplexed by cell units, wiring to each memory cell is multiplexed, causing the circuitry to become very complex to thereby significantly increase the cost as compared to single port memory.

In bank-based multiport memory, multiplexing is performed only between bank blocks to thereby simplify the circuitry. And each bank block is structured by typical single port memory architecture, thereby achieving memory array multiplexing at low cost.

Nevertheless, in the bank-based multiport memory, in which different bank blocks can be simultaneously accessed from a plurality of ports, access conflict may occur when the same bank block is accessed. Thus, in a case where a bank-based multiport memory is used as a unified cache, a problem arises in that access conflict occurs between instruction processing and data processing to cause the parallel processing efficiency to decrease.

### SUMMARY OF THE INVENTION

It is therefore an object of the present invention to provide a cache memory system that can reduce access conflicts without a great increase in cost, when used as a unified cache.

An inventive cache memory system includes: a plurality of cache lines, each including a data section for storing data of main memory and a line classification section for storing identification information that indicates whether the data stored in the data section is for instruction processing or for data processing; a cache hit determination section for determining whether or not there is a cache hit by using the identification information stored in each of the cache lines; and a cache update section for updating one of the cache lines that has to be updated, according to result of the determination.

In the inventive cache memory system, since the identification information is stored in each of the cache lines, instruction cache and data cache are distinguishable by the cache line. It is thus possible to prevent the occurrence of access conflict between instruction processing and data processing.

According to the present invention, the identification information is used for cache hit determination, and the cache lines, in which data is stored, can be distinguished between instruction use and data use according to the type of identification information. Thus, no access conflict occurs between instruction processing and data processing. When a bank-based multiport memory is used as a unified cache, no access arbitration is necessary, allowing the device cost to be reduced.

### BRIEF DESCRIPTION OF THE DRAWINGS

FIG. 1 is a block diagram illustrating the configuration of a cache memory system according to a first embodiment of the present invention.

FIG. 2 is an explanatory view illustrating the configuration of a cache line 20 included in a cache memory 40 shown in FIG. 1.

FIG. 3A is an explanatory view illustrating an address map in a bank-based multiport memory used in the cache memory 40, in which one bank is allocated to one cache line. FIG. 3B is an explanatory view illustrating an address map in a bank-based multiport memory used in the cache memory 40, in which two banks are allocated to one cache line.

FIG. 4A is an explanatory view indicating operation of a cache hit determination section 50 shown in FIG. 1 and operation of a cache update section 60 shown in FIG. 1. FIG. 4B is an explanatory view indicating cache line determination according to the first embodiment.

FIG. 5A is an explanatory view indicating operation of a cache hit determination section 150 and operation of a cache update section 160 according to a second embodiment. FIG. 5B is an explanatory view indicating cache line determination according to the second embodiment.

FIG. 6 is a block diagram illustrating the configuration of a unified cache.

FIG. 7 is a block diagram illustrating the configuration of a separate cache.

FIG. 8 is a block diagram illustrating the configuration of a multiport unified cache.

### DETAILED DESCRIPTION OF THE INVENTION

Hereinafter, embodiments of the present invention will be described with reference to the accompanying drawings.

### First Embodiment

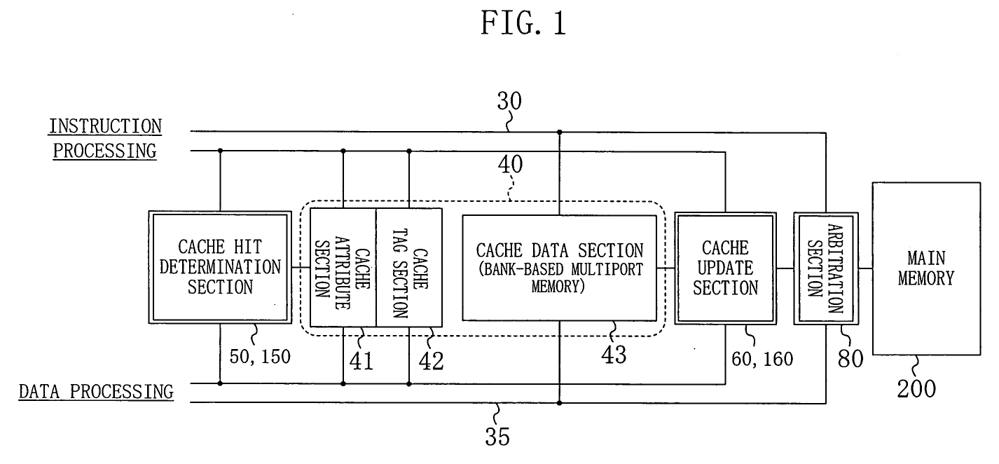

FIG. 1 is a block diagram illustrating the configuration of a cache memory system according to a first embodiment of the present invention. The cache memory system shown in FIG. 1 includes a cache memory 40, an instruction bus 30, a data bus 35, a cache hit determination section 50, a cache update section 60, and an arbitration section 80. The cache memory 40 includes a cache attribute section 41, a cache tag section 42, and a cache data section 43. The cache memory 40 includes a bank-based multiport memory and serves as a unified cache which is shared by instruction processing and data processing.

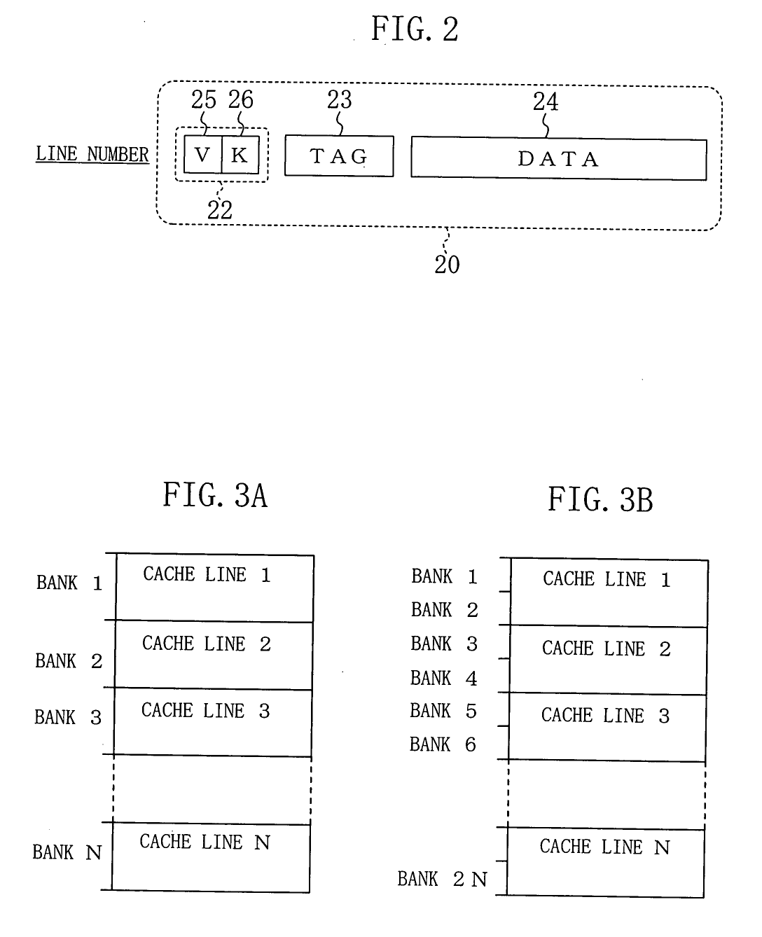

FIG. 2 is an explanatory view illustrating the configuration of a cache line 20 included in the cache memory 40 shown in FIG. 1. The cache line 20 includes an attribute section 22, a tag section 23, and a data section 24. The attribute section 22 includes a valid information section 25 and a line classification section 26. The valid information section 25 stores valid information that indicates whether or not contents in the cache line 20 are valid. The line classification section 26 stores identification information (line classification) that indicates whether data stored in the data section 24 in the cache line 20 is for instruction processing or for data processing. The data section 24 stores data of main memory 200 shown in FIG. 1. The tag section 23 stores address information corresponding to an address in the main memory 200 at which data that is the same as the data held in the data section 24 is stored.

The cache memory 40 shown in FIG. 1 includes a plurality of cache lines having the same structure as the cache line 20. The cache attribute section 41, the cache tag section 42, and the cache data section 43 include the attribute sections 22, the tag sections 23, and the data sections 24 of these cache lines, respectively. These cache lines correspond to different line numbers (lines 1 to N).

Upon receipt of a request address from instruction processing or from data processing, the cache hit determination section 50 determines whether or not data corresponding to the request address is present in the cache memory 40 (i.e., whether or not there is a cache hit), by using pieces of identification information stored in the respective cache lines.

When the determination result is a cache hit, the hitting cache line in the cache data section 43 is accessed through the instruction bus 30 in the case of instruction processing or through the data bus 35 in the case of data processing. When the determination result is not a cache hit (i.e., when the determination result is a cache miss), the cache update section 60 reads the data from the main memory 200 and updates a cache line in the cache memory 40 that should be updated.

FIG. 3A is an explanatory view illustrating an address map in the bank-based multiport memory used in the cache memory 40, in which one bank is allocated to one cache line. FIG. 3B is an explanatory view illustrating an address map in the bank-based multiport memory used in the cache memory 40, in which two banks are allocated to one cache line.

As shown in FIGS. 3A and 3B, the boundaries between the cache lines and the boundaries between the banks are aligned so that occurrence of access conflicts can be prevented in cases where different cache lines are accessed by instruction processing and by data processing.

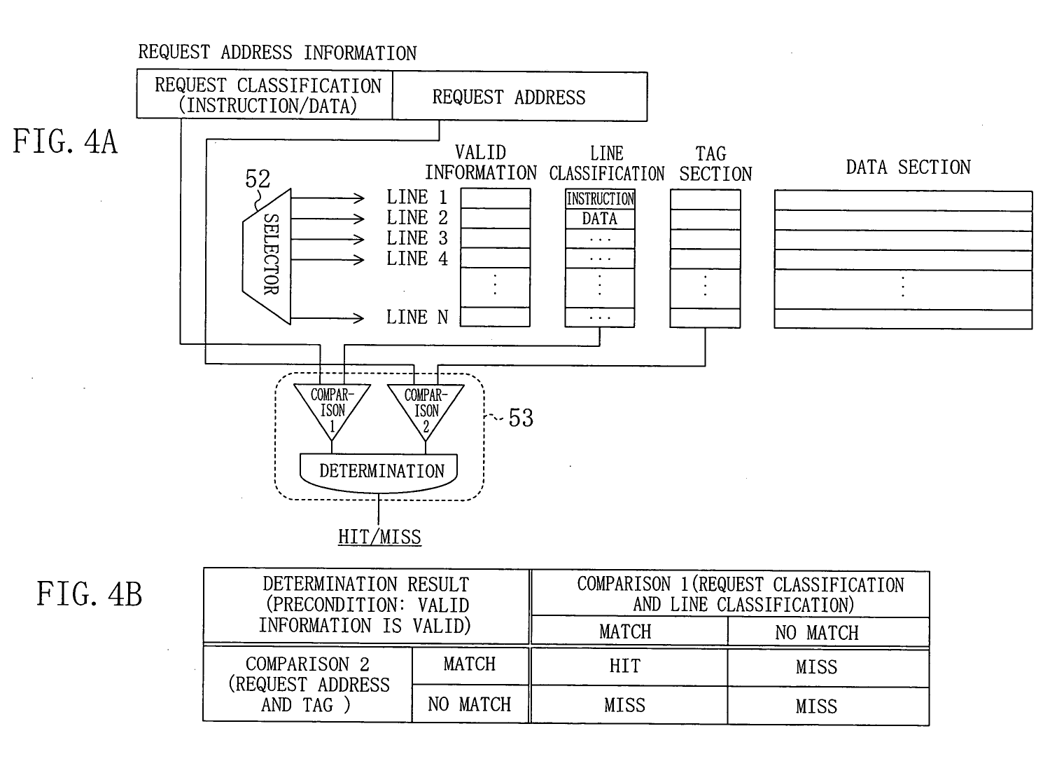

FIG. 4A is an explanatory view indicating operation of the cache hit determination section 50 and operation of the cache update section 60 shown in FIG. 1. FIG. 4B is an explanatory view illustrating cache line determination according to the first embodiment.

In the following description, it is assumed that the cache memory 40 in FIG. 1 is a fully-associative cache, for example, and that all cache lines included in the cache memory 40 are subjected to cache hit determination. Also, request address information contains a request classification and a request address. The request classification indicates whether the access is made by instruction processing or by data processing.

The cache hit determination section 50 includes a selector 52 and a determination processing section 53. When the cache hit determination section 50 receives request address information, the selector 52 selects a cache line sequentially starting from the line 1 to the line N, and according to determination conditions shown in FIG. 4B, the determination processing section 53 compares the received request address information to all cache lines to determine whether or not there is a hit. That is, if the request classification matches the identification information in a cache line, and the request address matches the address information in the tag section in that cache line, then the cache hit determination section 50 determines that the request is a hit. In the other cases, the cache hit determination section 50 determines that the request is a miss.

In other words, in a case where an access is made by instruction processing, if the identification information in the cache line that corresponds to the requested address indicates that the data stored in the data section in that cache line is for instruction processing, then the cache hit determination section 50 determines that that cache line is the hitting line. In a case where an access is made by data processing, if the identification information in the cache line that corresponds to the requested address indicates that the data stored in the data section in that cache line is for data processing, then the cache hit determination section 50 determines that that cache line is the hitting line.

In the case of the determination of a hit, the cache hit determination section 50 terminates the determination process at that point in time (i.e., the cache hit determination section 50 determines that there is a cache hit) and outputs the data in the hitting cache line. If the determination results for all cache lines are misses, the cache hit determination section 50 outputs data indicating a cache miss.

In the case where the cache hit determination section 50 outputs data indicating a cache miss, the cache update section 60 shown in FIG. 1 determines a cache line in the cache memory 40 that is to be updated, by using a predetermined cache change algorithm.

Next, the cache update section 60 reads data corresponding to the received request address from the main memory 200 and stores the read data in the data section 24 (shown in FIG. 2) in the cache line whose update has been determined. The cache update section 60 also changes the value of the valid information section 25 (shown in FIG. 2) in the cache line whose update has been determined to a value indicating “valid”, and stores the received request classification and request address in the line classification section 26 and the tag section 23 (shown in FIG. 2), respectively.

As described above, in the cache memory system shown in FIG. 1, the identification information that indicates instruction processing or data processing is stored in each cache line, and the stored identification information is used to determine whether or not there is a cache hit. Thus, cache lines corresponding to different identification information are distinguishable, thereby avoiding access conflicts.

### Second Embodiment

In a second embodiment, cache line copy function is added to the cache memory system of the first embodiment. A cache memory system according to the second embodiment is obtained by replacing the cache hit determination section 50 and the cache update section 60 in the cache memory system of the first embodiment shown in FIG. 1 with a cache hit determination section 150 and a cache update section 160, respectively.

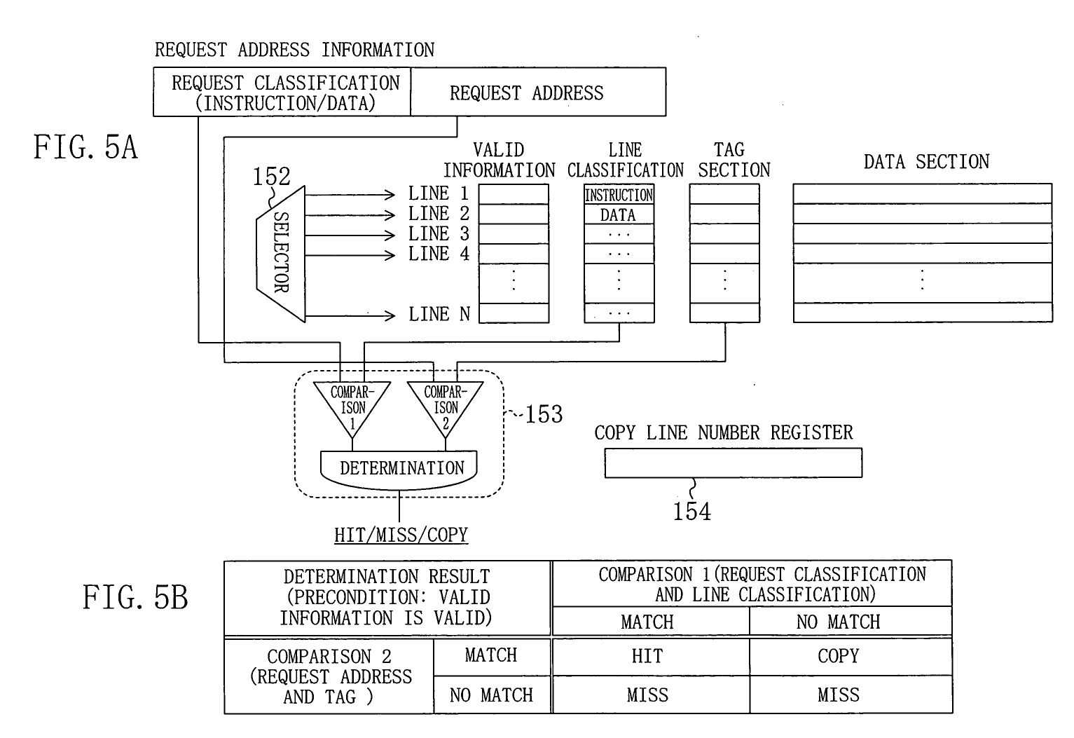

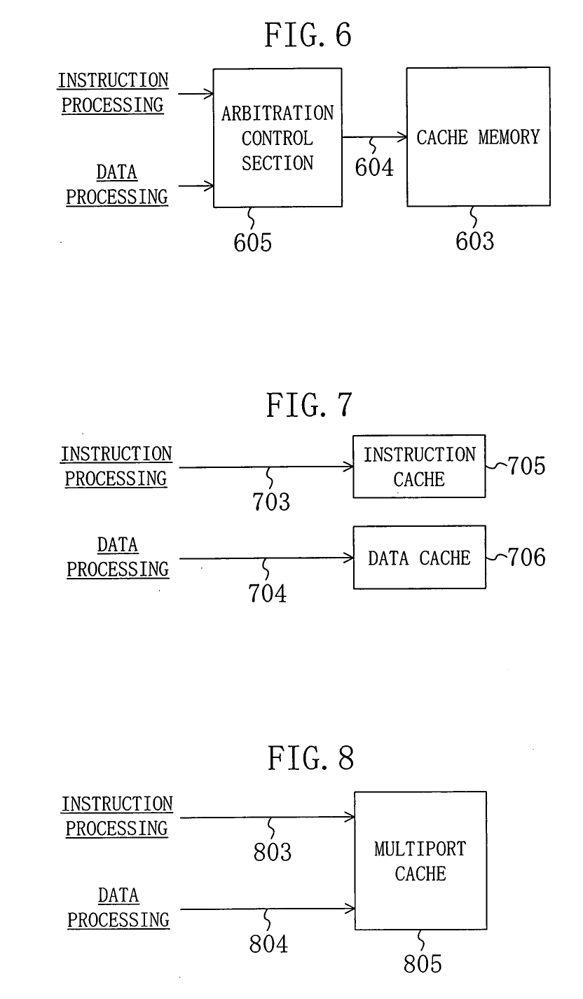

FIG. 5A is an explanatory view indicating operation of the cache hit determination section 150 and operation of the cache update section 160 according to the second embodiment. FIG. 5B is an explanatory view indicating cache line determination according to the second embodiment.

In the following description, it is assumed that the cache memory 40 in FIG. 1 is a fully-associative cache, and that all cache lines included in the cache memory 40 are subjected to cache hit determination.

The cache hit determination section 150 includes a selector 152, a determination processing section 153, and a copy line number register 154. Upon receipt of request address information, the cache hit determination section 150 initializes the copy line number register 154 by making the copy line number register 154 store the line number of an invalid cache line.

Next, the selector 152 selects a cache line sequentially starting from the line 1 to the line N, and according to determination conditions shown in FIG. 5B, the determination processing section 153 compares the received request address information to all cache lines to determine whether or not there is a cache hit. At this time, if the request address matches contents in the tag section 23 shown in FIG. 2, and the request classification does not match the identification information (line classification) held in the line classification section 26 shown in FIG. 2, then the determination processing section 153 determines that a copy should be made between cache lines, and stores in the copy line number register 154 the line number of the cache line thus determined to be copied. In the other cases, the determination processing section 153 operates in the same way as the determination processing section 53 of the first embodiment.

If determination results for all cache lines are other than cache hits, and the contents held in the copy line number register 154 are the line number of a valid cache line, then the cache hit determination section 150 outputs a cache copy signal to the cache update section 160.

On receiving the cache copy signal, the cache update section 160 determines a cache line that is to be updated, by using a predetermined cache change algorithm.

Next, the cache update section 160 copies data held in the data section 24 in the cache line having the line number retained in the copy line number register 154 to the data section 24 in the cache line whose update has been determined. The cache update section 160 also changes the value of the valid information section 25 in the cache line whose update has been determined to a value indicating “valid”, and stores the received request classification and request address in the line classification section 26 and the tag section 23, respectively. At this time, data to be updated is not read from the main memory 200 shown in FIG. 1.

In this manner, in the case in which the type of access processing does not match the identification information, and there is a cache line where data that is the same as the data to be accessed is stored, that same data is copied to another cache line. Then, this data can be used for the same type of processing as that access without accessing the main memory. It is thus possible to reduce accesses to the relatively low speed main memory, thereby increasing processing speed.

In the first and second embodiments, the cache update sections 60 and 160 shown in FIG. 1 may assign the order of priority to the identification information stored in the line classification section 26 shown in FIG. 2 in accordance with the type of the identification information. And in performing a cache line update, the cache update sections 60 and 160 may determine a cache line to be updated according to the order of priority of the identification information. For example, if contents in many of the cache lines whose identification information indicates data processing are desired to be held, the cache update sections 60 and 160 update cache lines whose identification information indicates instruction processing with priority. That is, data in cache lines having a specific type of identification information can be updated or held with priority.

As described above, the present invention, which reduces conflicts in cache memory access without a great increase in cost, is applicable to handheld terminals, mobile phones, etc., and also applicable to information equipment, such as personal computers and information appliances, as well as to general systems using cache memory.

What is claimed is:

1. A cache memory system, comprising:
a plurality of cache lines, each including a data section for storing data of main memory and a line classification section for storing identification information that indicates whether the data stored in the data section is for instruction processing or for data processing;
a cache hit determination section for determining whether or not there is a cache hit by using the identification information stored in each of the cache lines; and
a cache update section for updating one of the cache lines that has to be updated, according to result of the determination.

2. The cache memory system of claim 1, wherein in a case where an access is made by instruction processing, a necessary condition for the cache hit determination section to determine that there is a cache hit is that the identification information in one of the cache lines that corresponds to a requested address indicates that the data stored in the data section in that cache line is for instruction processing.

3. The cache memory system of claim 1, wherein in a case where an access is made by data processing, a necessary condition for the cache hit determination section to determine that there is a cache hit is that the identification information in one of the cache lines that corresponds to a requested address indicates that the data stored in the data section in that cache line is for data processing.

4. The cache memory system of claim 1, wherein in a case where an access is made by instruction processing and one of the cache lines that has been targeted for update is updated, the cache update section makes the line classification section in that target cache line store the identification information indicating that the data stored in the data section in that target cache line is for instruction processing.

5. The cache memory system of claim 1, wherein in a case where an access is made by data processing and one of the cache lines that has been targeted for update is updated, the cache update section makes the line classification section in that target cache line store the identification information indicating that the data stored in the data section in that target cache line is for data processing.

6. The cache memory system of claim 1, wherein the cache lines are configured by using a bank-based multiport memory.

7. The cache memory system of claim 1, wherein each of the cache lines further includes a tag section for storing address information corresponding to an address in the main memory at which data that is the same as the data stored in the data section is stored; and
if, in one of the cache lines, the identification information does not match a request classification indicating whether a received access has been made by instruction processing or by data processing, and an address specified by that access matches the address in the tag section, the cache update section copies contents in the data section in that cache line to the data section in a different one of the cache lines and makes the tag section and the line classification section in that different cache line store the address specified by that access and the identification information indicating the request classification, respectively.

8. The cache memory system of claim 1, wherein the cache update section assigns the order of priority to the identification information in accordance with the type of the identification information and determines one of the cache lines that is to be updated, according to the assigned order of priority.
